(19) United States
(12) Patent Application Publication
(10) Pub. No.: US 2007/0165800 A1
(43) Pub. Date: Jul. 19, 2007

(54) Connection control apparatus, method, and program

(75) Inventors: Shiro Imura, Tokyo (JP); Hiroshi Kurihara, Tokyo (JP); Mitsuhisa Shimamori, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/606,380

(22) Filed: Nov. 30, 2006

(30) Foreign Application Priority Data
Dec. 6, 2005 (JP) 2005-351431

(51) Int. Cl. H04M 11/00

(52) U.S. Cl. 379/100.12

(57) ABSTRACT

A connection control server provided on a network is operable to control a connection state of telephone terminals connected to each other via the network. The connection control server has a command notification reception processing unit for receiving a switching request of a session established between telephone terminals from a user terminal connected to the network, and a session control processing unit for switching a connection of the session between the telephone terminals in response to the switching request.

### BACKGROUND OF THE INVENTION

The present invention relates to a connection control apparatus and more particularly to a connection control apparatus for controlling a connection of telephone terminals. Further, the present invention also relates to a connection control method and program.

Conventionally, only a call between two parties could be provided in use of telephone terminals. However, various call functions have recently been implemented by development of communication control technology and telephone terminals. For example, there have been available various functions such as a function of call redirection which performs to transfer a connection ends (nodes) of a telephone terminal to another telephone terminal during a telephone conversation and a function of connecting three or more telephone terminals to each other so as to provide a three-party call. Further, there also has been available a function of playing music such as music-on-hold for a connected telephone terminal by a command from another device. Japanese laid-open patent publication No. 5-114954 concretely discloses technology of telephone call redirection and a three-party call.

The functions of telephone call redirection and a three-party call disclosed in the prior art are performed when a function button provided on a telephone terminal is pushed. In other words, if a telephone terminal does not have any device to implement those functions, then it is impossible to perform those functions. Accordingly, in order to provide various functions as described above, a telephone terminal should be made multifunctional. Thus, cost for introducing a telephone terminal is increased.

Further, a telephone number of a call redirection telephone terminal or a third party should be inputted directly from a telephone terminal for telephone call redirection or a three-party call. Thus, it takes much time for operation. Further, a typing error may be made during operation. When a music playing service such as music-on-hold is provided, a similar problem may arise.

In the music playing service, only predetermined pieces of music can be provided to users. Accordingly, users cannot freely change sound information including music to be provided. Thus, users have a low level of satisfaction.

In order to use various functions such as telephone call redirection and a three-party call with a telephone terminal, all telephone terminals are required to have a device to implement those functions. Accordingly, new telephone terminals should be introduced, and it takes much time for operation.

### SUMMARY OF THE INVENTION

An object of the present invention is to improve the aforementioned disadvantages of the prior art.

More specifically, the object of the present invention is to provide a new telephone service by using existing telephone terminals, such as an insertion of a sound effect or a call with BGM as well as holding and call redirection, without introduction of new telephone terminals.

According to first aspect of this invention, there is provided a connection control apparatus, disposed on a network, for controlling a connection state of telephone terminals connected to each other via the network. The connection control apparatus comprises switching request reception means for receiving a switching request of a session established between said telephone terminals from an information processing terminal connected to the network and connection switching means for switching connection ends (nodes) of the session between the telephone terminals in response to the switching request. The connection switching means is operable to switch at least one of the connection ends (nodes) in the session between the telephone terminals into another device. The connection switching means is operable to call the other device and connect the other device to at least one of telephone terminals serving as the connection ends (nodes) in the session. The connection switching means is operable to call the other device and connect the other device to both telephone terminals serving as the connection ends (nodes) in the session. The connection switching means is operable to call another telephone terminal as the other device and connect the other telephone terminal to the at least one of telephone terminals serving as the connection ends (nodes) in the session. The connection switching means is operable to call, as the other device, a media server for providing content information including a sound and an image to the telephone terminals and connect the media server to at least one of telephone terminals serving as the connection ends (nodes) in the session. The connection switching means is operable to call, as the other device, a mixing server for mixing information supplied from predetermined devices connected thereto to produce the mixed input information to the connected predetermined devices and connect the media server to at least one of telephone terminals serving as the connection ends (nodes) in the session. The connection switching means is operable to call a third party's telephone terminal and connect the third party's telephone terminal to the mixing server. The connection switching means is operable to switch the connection ends (nodes) of the session via a call control server, disposed on the network, for performing a call control and a connection control for telephone terminals.

According to second aspect of this invention, there is provided a web server, connected to a connection control apparatus disposed on a network, for opening a website which receives access from an information processing terminal connected to the network. The web server comprises switching command reception means for receiving a switching request of a session established between telephone terminals connected to each other via the network from the information processing terminal and for notifying the connection control apparatus of the switching request. The web server further comprises switching content information storage means for preliminarily storing switching content of the session and switching content display means for displaying the switching content on the information processing terminal in a selectable manner. The switching command reception means is operable to receive, as a switching command, switching content selected from the information processing terminal on an indication by said switching content display means. The switching content display means is operable to display, as the switching content, an indication of call redirection and telephone numbers of destination of the call redirection on the information processing terminal. The switching content display means is operable to display, as the switching content, an indication of a three-party call and telephone numbers of a possible third party to be added on the information processing terminal. The switching content display means is operable to display, as the switching content, an indication of transmission of predetermined content information to a telephone terminal and a list of content information to be selected on the information processing terminal.

According to third aspect of this invention, there is provided a connection control system comprises a connection control apparatus disposed on a network and a web server connected to said connection control apparatus. The connection control apparatus controls a connection state of telephone terminals connected to each other via the network. The web server opens a website which receives access from an information processing terminal connected to the network. The web server comprises switching command reception means for receiving a switching request of a session established between the telephone terminals from the information processing terminal and for notifying said connection control apparatus of the switching request. The connection control apparatus comprises switching request reception means for receiving the switching request and connection switching means for switching connection ends (nodes) of the session between the telephone terminals in response to the switching request. The connection switching means is operable to switch at least one of the connection ends (nodes) in the session between the telephone terminals into another device. The connection switching means is operable to call the other device and connect the other device to at least one of telephone terminals serving as the connection ends (nodes) in the session. The connection switching means is operable to call the other device and connect the other device to both of the telephone terminals serving as the connection ends (nodes) in the session. The connection switching means is operable to call another telephone terminal as the other device and connect the other telephone terminal to the at least one of the telephone terminals serving as the connection ends (nodes) in the session. The connection switching means is operable to call, as the other device, a media server for providing content information including a sound and an image to the telephone terminals and connect the media server to at least one of telephone terminals serving as the connection ends (nodes) in the session. The connection switching means is operable to call, as the other device, a mixing server for mixing information supplied from predetermined devices thereto to produce the mixed input information to the connected predetermined devices and connect the mixing server to at least one of telephone terminals serving as the connection ends (nodes) in the session. The connection switching means is operable to call a third party's telephone terminal and connect the third party's telephone terminal to the mixing server. The connection switching means is operable to switch the connection ends (nodes) of the session via a call control server, disposed on the network, for performing a call control and a connection control for telephone terminals. The web server further comprises switching content information storage means for preliminarily storing switching content of the session and switching content display means for displaying the switching content on the information processing terminal in a selectable manner. The switching command reception means is operable to receive, as a switching command, the switching content selected from the information processing terminal on an indication by said switching content display means. The switching content display means is operable to display, as the switching content, an indication of call redirection and telephone numbers of destination of the call redirection on the information processing terminal. The switching content display means is operable to display, as the switching content, an indication of a three-party call and telephone numbers of a possible third party to be added on the information processing terminal. The switching content display means is operable to display, as the switching content, an indication of transmission of content information to a telephone terminal and a list of content information to be selected on the information processing terminal.

According to fourth aspect of this invention, there is provided a program for controlling, by a connection control computer disposed on a network, a connection state of telephone terminals connected to each other via the network. The program making the connection control computer execute the steps of receiving a switching request of a session established between the telephone terminals from an information processing terminal connected to the network and switching connection ends (nodes) of the session between the telephone terminals in response to the switching request. The switching step switches at least one of the connection ends (nodes) in the session between the telephone terminals into another device. The switching step calls the other device and connects the other device to at least one of telephone terminals serving as the connection ends (nodes) in the session. The switching step calls the other device and connects the other device to both of the telephone terminals serving as the connection ends (nodes) in the session. The switching step calls another telephone terminal as the other device and connects the other telephone terminal to the at least one of the telephone terminals serving as the connection ends (nodes) in the session. The switching step calls, as the other device, a media server for providing content information including a sound and an image to the telephone terminals and connects the media server to at least one of telephone terminals serving as the connection ends (nodes) in the session. The switching step calls, as the other device, a mixing server for mixing information supplied from predetermined device connected thereto to produce the mixed input information to the connected predetermined devices. Then the switching step connects the media server to at least one of telephone terminals serving as the connection ends (nodes) in the session.

According to fifth aspect of this invention, there is provided a program for making the web server execute a process, the web server being connected to a connection control apparatus disposed on a network, the connection control apparatus controlling a connection state of telephone terminals connected to each other via the network, the web server opening a website which receives access from an information processing terminal connected to the network. The process comprising the step of receiving a switching request of a session established between the telephone terminals from the information processing terminal to notify the connection control apparatus of the switching request. The process further comprises a step of displaying switching content of the session which is preliminarily stored in switching content information storage means on the information processing terminal in a selectable manner. The receiving step receives, as a switching command, the switching content selected on an indication by said displaying step. The displaying step displays, as the switching content, an indication of call redirection and telephone numbers of destination of the call redirection on the information processing terminal. The displaying step displays, as the switching content, an indication of a three-party call and telephone numbers of a possible third party to be added on the information processing terminal. The displaying step displays, as the switching content, an indication of transmission of content information to a telephone terminal and a list of content information to be selected on the information processing terminal.

According to sixth aspect of this invention, there is provided a connection control method of controlling, in a connection control apparatus disposed on a network, a connection state of telephone terminals connected to each other via the network. The method comprises a switching request receiving step of receiving a switching request of a session established between the telephone terminals from an information processing terminal connected to the network and a connection switching step of switching connection ends (nodes) of the session between the telephone terminals in response to the switching request. The connection switching step comprises a step of switching at least one of telephone terminals serving as the connection ends (nodes) in the session between the telephone terminals into another device. The connection switching step comprises a step of calling the other device to connect the other device to at least one of telephone terminals serving as the connection ends (nodes) in the session. The connection switching step comprises a step of calling the other device to connect the other device to both of the telephone terminals serving as the connection ends (nodes) in the session. The connection switching step comprises a step of calling another telephone terminal as the other device to connect the other telephone terminal to the at least one of the connected telephone terminals serving as the connection ends (nodes) in the session. The connection switching step comprises the steps of calling, as the other device, a media server for providing content information including a sound and an image to the telephone terminals as the other device and connecting the media server to at least one of telephone terminals serving as the connection ends (nodes) in the session. The connection switching step comprises the steps of calling, as the other device, a mixing server for mixing information supplied from predetermined devices connected thereof to produce the mixed input information to the connected predetermined devices and connecting the media server to at least one of telephone terminals serving as the connection ends (nodes) in the session. The connection switching step further comprises the steps of calling a third party's telephone terminal and connecting the media server to the third party's telephone terminal. The connection control method further comprises a switching command reception step before said switching request reception step in which a web server, connected to the connection control apparatus, for opening a website which receives access from the information processing terminal receives a switching request of a session established between the telephone terminals on the website to notify the connection control computer of the switching request. The connection control method further comprises a switching content display step before said switching command reception step in which the web server displays switching content of the session which is preliminarily stored in switching content information storage means on the information processing terminal in a selectable manner. The switching command reception step comprises a step of receiving, as said switching command, the switching content selected on an indication by said switching, content display step. The switching content display step comprises a step of displaying, as the switching content, an indication of call redirection and telephone numbers of destination of the call redirection on the information processing terminal. The switching content display step comprises a step of displaying, as the switching content, an indication of a three-party call and telephone numbers of a possible third party to be added on the information processing terminal. The switching content display step comprises a step of displaying, as the switching content, as an indication of transmission of content information to a telephone terminal and a list of content information to be selected on the information processing terminal.

### BRIEF DESCRIPTION OF THE DRAWINGS

FIG. 1 is a block diagram showing a configuration of an entire network according to a first embodiment of the present invention;

FIG. 2 is a functional block diagram showing a configuration of a connection control system shown in FIG. 1;

FIG. 3 is a diagram showing an example of an operation screen displayed on a user terminal in the present invention;

FIG. 4 is an explanation diagram showing operation in the first embodiment;

FIG. 5 is an explanation diagram showing operation in the first embodiment;

FIG. 6 is a sequence diagram showing operation in the first embodiment;

FIG. 7 is a sequence diagram showing operation in the first embodiment;

FIG. 8 is a network diagram showing a variation of the first embodiment;

FIG. 9 is a network diagram showing another variation of the first embodiment;

FIG. 10 is a block diagram showing a configuration of an entire network according to a second embodiment of the present invention;

FIG. 11 is an explanation diagram showing operation in the second embodiment;

FIG. 12 is an explanation diagram showing operation in the second embodiment;

FIG. 13 is a sequence diagram showing operation in the second embodiment;

FIG. 14 is a block diagram showing a configuration of an entire network according to a third embodiment of the present invention;

FIG. 15 is an explanation diagram showing operation in the third embodiment;

FIG. 16 is an explanation diagram showing operation in the third embodiment; and

FIG. 17 is a sequence diagram showing operation in the third embodiment.

### DESCRIPTION OF THE PREFERRED EMBODIMENTS

The present invention has the following features. Switching of a session between telephone terminals can be controlled without any special functions mounted on the telephone terminals by a connection control apparatus provided on a network. Accordingly, various functions including telephone call redirection and a three-party call can be provided.

A first embodiment relates to telephone call redirection, a second embodiment relates to a three-party call, and a third embodiment relates to a case where sound information or the like is provided to telephone terminals.

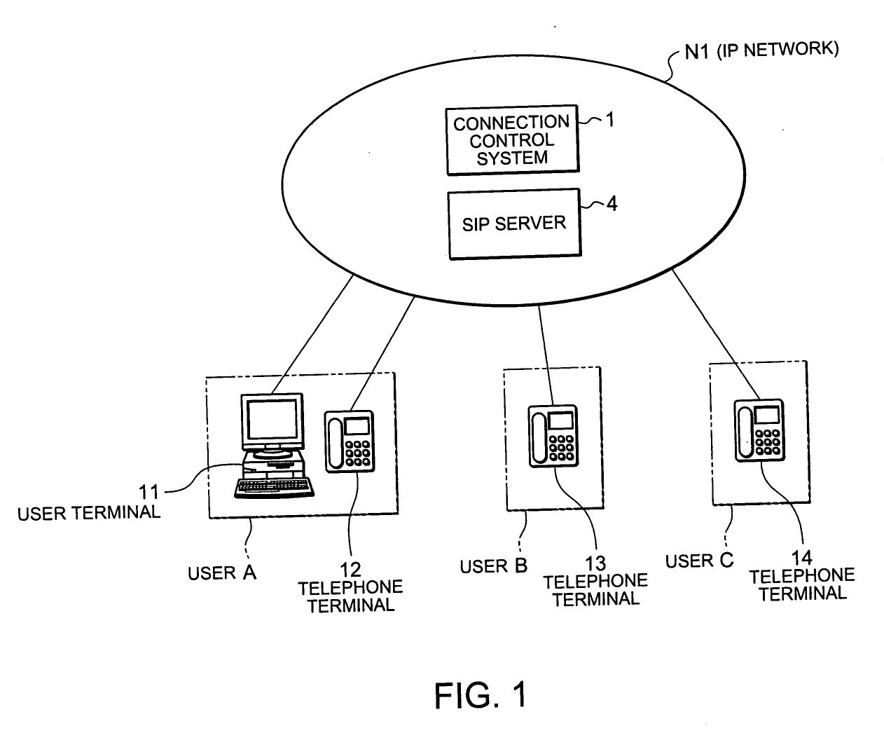

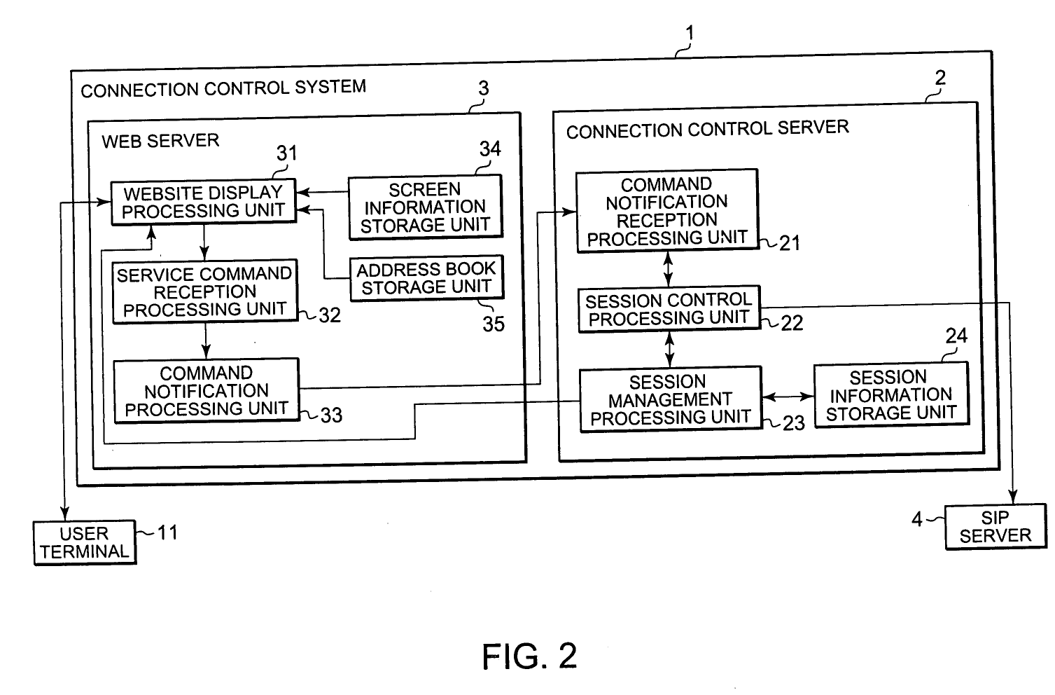

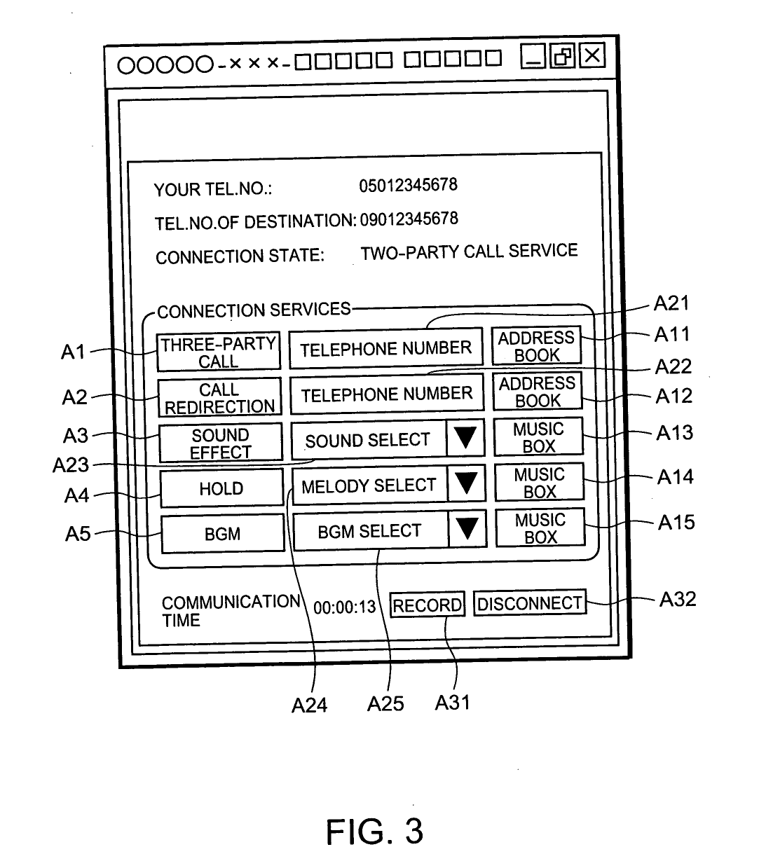

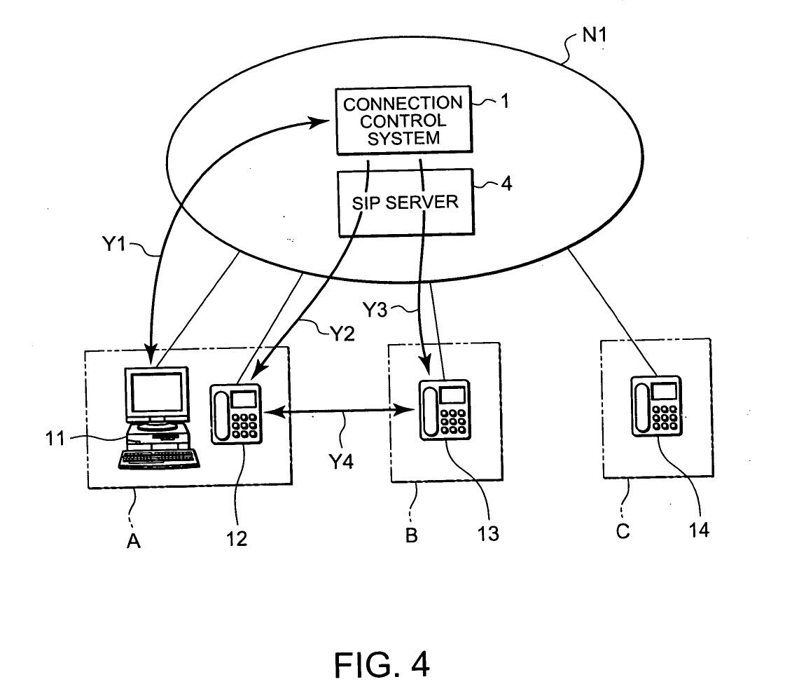

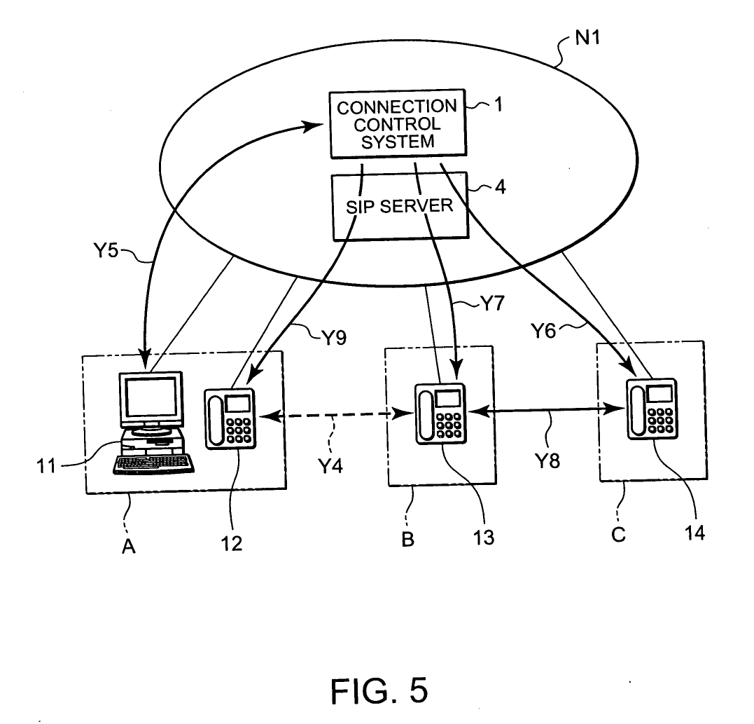

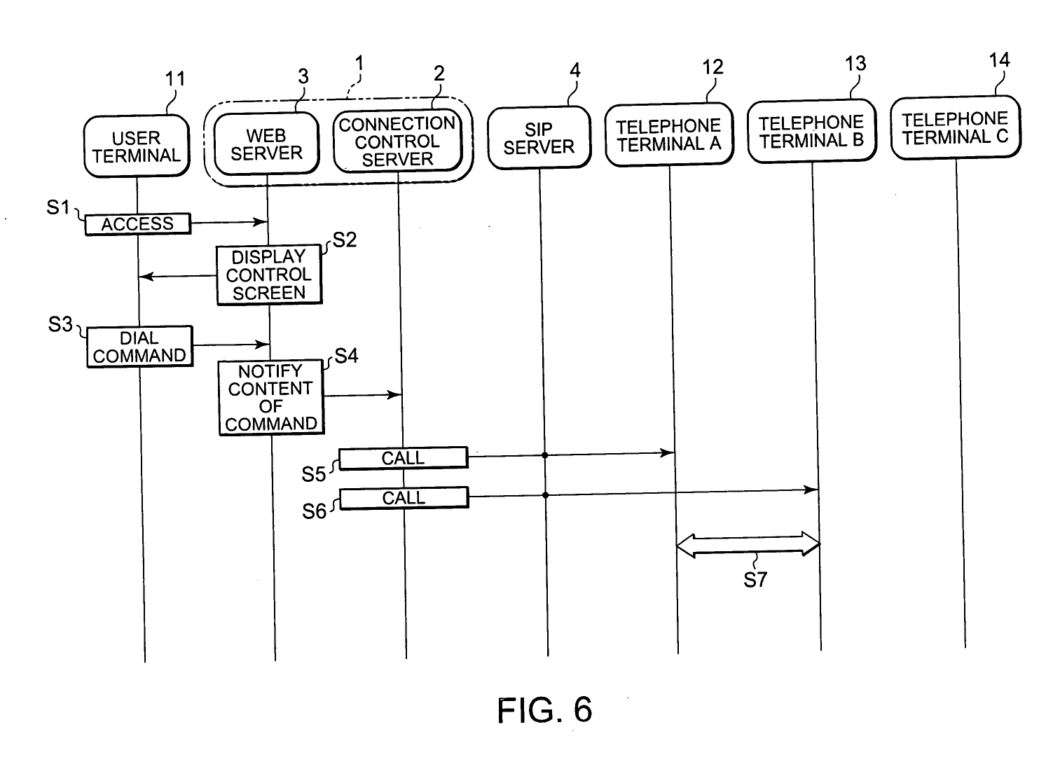

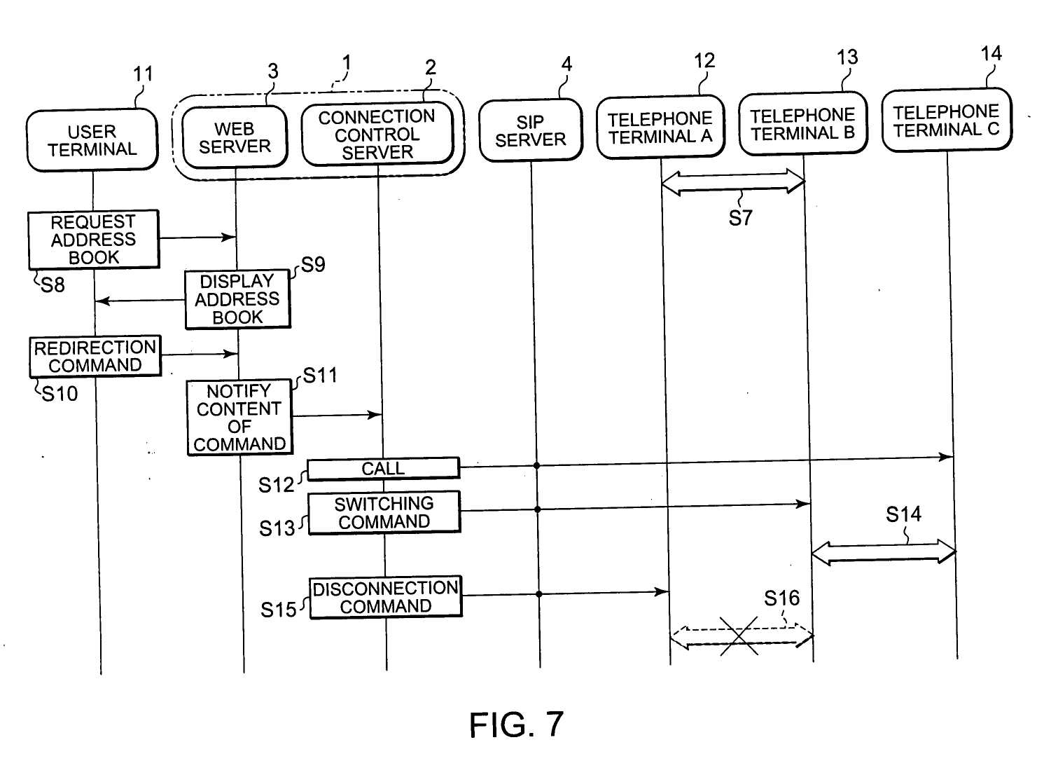

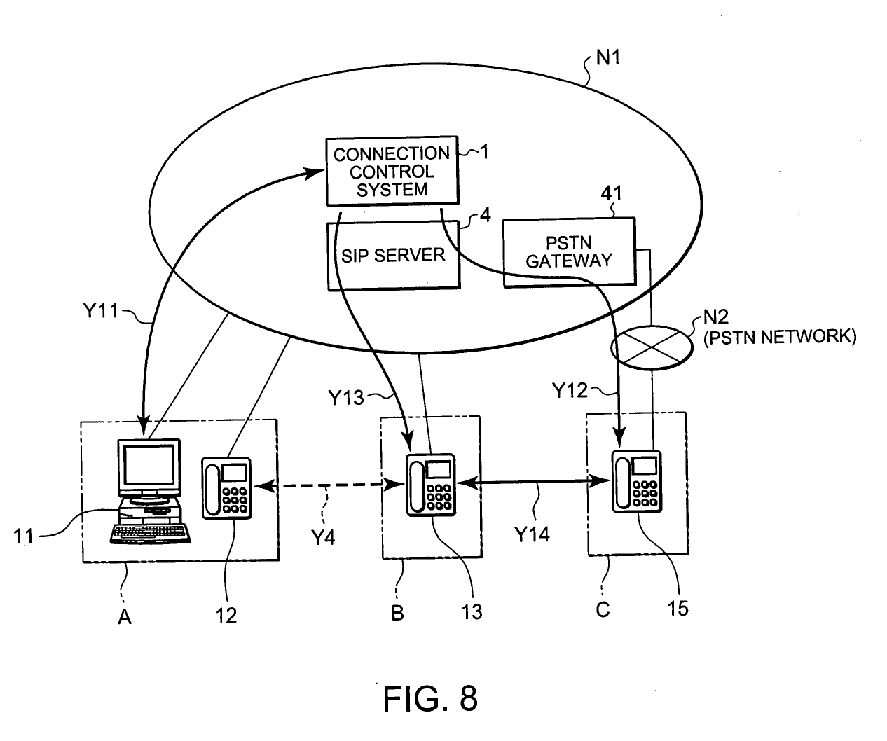

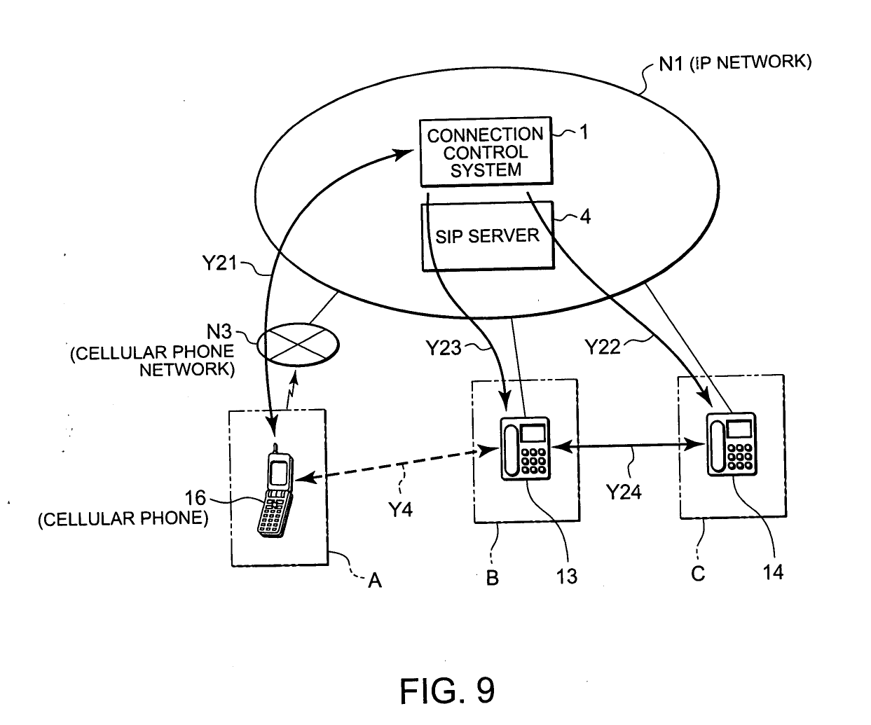

A first embodiment of the present invention will be described with reference to FIGS. 1 to 9. FIG. 1 is a block diagram showing a configuration of an entire network according to the first embodiment of the present invention. FIG. 2 is a functional block diagram showing a configuration of a connection control system. FIG. 3 is a diagram showing an example of an operation screen displayed on a user terminal. FIGS. 4 and 5 are explanation diagrams showing operation in the first embodiment. FIGS. 6 and 7 are sequence diagrams showing operation in the first embodiment. FIGS. 8 and 9 are explanation diagrams showing variations of the first embodiment.

FIG. 1 shows a network configuration in the first embodiment. As shown in FIG. 1, a user terminal 11 such as a personal computer of a user A, a telephone terminal 12 such as an Internet Protocol (IP) telephone of the user A, a telephone terminal 13 of a user B, and a telephone terminal 14 of a user C are connected to an IP network N1. Although various devices including other telephone terminals are connected to the IP network N1, those devices are omitted from the drawings.

Further, a Session Initiation Protocol (SIP) server 4 (call control server) is disposed on the IP network N1. The SIP server 4 performs a call control and a connection control for IP telephones or other telephones in accordance with an SIP protocol. Furthermore, a connection control system 1 is disposed on the IP network N1. As shown in FIG. 2, the connection control system 1 includes a connection control server 2 and a web server 3 for providing a website. The connection control server 2 performs a connection control for telephone terminals so as to implement functions such as telephone call redirection, which will be described later. Details of the system will be described below.

The user terminal 11 is an information processing terminal having an Internet connection function, such as a personal computer owned and operated by the user A. The user terminal 11 can access a website provided by the web server 3. Further, the user terminal 11 allows the user A to view public web pages of websites with use of website viewing software (browser). The user terminal 11 is used to input a connection command or a connection switching command while the user A uses the telephone terminal 12. When the user A is to use the telephone terminal 12, the user terminal 11 is connected to the web server 3, and a connection receiver of the telephone terminal 12 is specified with use of the user terminal 11.

The telephone terminals 12, 13, and 14 are IP telephone terminals used by the users A, B, and C, respectively. Each of the telephone terminals 12, 13, and 14 can be connected to other devices according to a call control or a connection control performed by the SIP server 4 provided on the IP network N1. For example, when the telephone terminal 14 receives a call from the SIP server 4 and responds the call, a session is established between the telephone terminal 14 and another telephone terminal so as to enable a telephone conversation therebetween.

The SIP server 4 transmits a command (message) from the connection control server 2 to the telephone terminals 12, 13, and 14 and performs a call control and a connection control. Specifically, the SIP server 4 transmits a message to call the telephone terminal 12, 13, and 14, a message to request an establishment of a session, and a message to switch a connection of an established session.

FIG. 2 shows the configuration of the connection control system 1 including the connection control server 2 and the web server 3. The connection control server 2 (connection control apparatus) is a general server computer having a processing device such as a CPU, which will be described later, and a storage device such as a hard disk drive, which will be described later. Preset programs have been incorporated into the processing device. As shown in FIG. 2, the processing device includes a command notification reception processing unit 21, a session control processing unit 22, and a session management processing unit 23. The storage device serves as a session information storage unit 24.

The command notification reception processing unit (switching request reception means) 21 has a function of receiving a switching request of a session, which has been transmitted from the user terminal 11 and received by the web server 3, from the web server 3. The command notification reception processing unit 21 transmits the switching request to the session control processing unit 22.

The session control processing unit (connection switching means) 22 performs a switching control of a connection of a session between telephone terminals in accordance with the switching request of the session, which has been received from the user terminal 11 via the command notification reception processing unit 21. The switching process of the session is performed by call redirection a command from the session control processing unit 22 to the SIP server 4 and call redirection the command from the SIP server 4 to the telephone terminal 12.

The session control processing unit 22 will be described in detail. In the present embodiment, the session control processing unit 22 receives a telephone call redirection command and a telephone number of a call redirection telephone terminal as a switching request from the user terminal 11. The session control processing unit 22 calls the call redirection telephone terminal 14 based on the call redirection telephone number. The session control processing unit 22 controls so as to switch at least one of telephone terminals in a session established between the telephone terminals into the call redirection telephone terminal 14 via the SIP server 4. In this case, any one of connected telephone terminals or both of connected telephone terminals may be forwarded.

The session management processing unit 23 and the session information storage unit 24 hold information of a session status to be subjected to a switching control. Specifically, a session to be subjected to a switching control is specified based on information recognized by the connection control server 2, and then a switching process is performed on the specified session.

Further, the session management processing unit 23 has a function of notifying the web server 3 of information of a session status that relates to a specific user's telephone terminal among the information of the session status held by the connection control server 2.

Next, a configuration of the web server 3 will be described. The web server 3 is a general server computer having a processing unit such as a CPU, which will be described later, and a storage device such as a hard disk drive, which will be described later. Preset programs have been incorporated into the processing unit. As shown in FIG. 2, the processing unit includes a website displays processing unit 31, a service command reception processing unit 32, and a command notification processing unit 33. The storage device includes a screen information storage unit 34 and an address book storage unit 35.

The website display processing unit (switching content display means) 31 transmits control screen information, which is used to input a command for controlling a connection state of the telephone terminal 12 of the user A, to a browser of the accessing user terminal 11. The website displays processing unit 31 requires a user ID and a password of the accessing user terminal 11 so as to perform a user authentication. Thus, a user is specified, and control screen information corresponding to the specified user is transmitted to the user terminal 11. For example, the website displays processing unit 31 acquires information indicative of a connection state of a specified user's telephone terminal from the session management processing unit 23 of the connection control server 2 and displays the acquired information on a display unit of a user terminal. The website displays processing unit 31 is operable to display contents of switching services available to a user on a display unit of a user terminal. Further, the website displays processing unit 31 acquires telephone numbers of a third party from an address book associated with a user and displays the acquired telephone numbers on a display unit of a user terminal. The control screen information to be displayed on a display unit of the user terminal 11, i.e., selectable types of switching contents in a session or telephone numbers of a third party, is stored in the screen information storage unit 34 or the address book storage unit 35. Thus, the storage units 34 and 35 serve as a switching content information storage means.

FIG. 3 shows an example of control screen information transmitted from the web server 3 to the user terminal 11 and displayed on the user terminal 11. As shown in FIG. 3, a telephone number of a telephone terminal of a user specified by a user authentication, a telephone number of a correspondent telephone terminal connected to the user's telephone terminal, and a current call status are displayed at an upper portion of the control screen. Further, buttons for selecting functions available in the present system and a screen field are displayed from a center to a lower portion of the control screen. Hereinafter, only functions necessary for the present embodiment will be described. Other functions will be described in second and third embodiments.

The connection control system according to the present embodiment has a call redirection function of transferring one of connected telephone terminals having a telephone conversation therebetween to a third party's telephone terminal. In order to implement this call redirection function, the control screen shown in FIG. 3 has a “call redirection” button A2, a “telephone number” Input field (box) A22 for inputting a call redirection telephone number, and an “address book” button A12 for displaying previously registered telephone numbers in a selectable manner. In the following description, pushing a button means user's clicking on the button with a mouse.

When the user A pushes the “address book” button A12, a list of registered telephone numbers is displayed on the control screen. When the user A selects one of the telephone numbers, the selected telephone number is automatically inputted into the “telephone number” input field (box) A22. When the user A then pushes the “call redirection” button A2, a call redirection command is transmitted from a browser of the user terminal 11 to the web server 3. The call redirection command includes information for identifying a connected session of the user's telephone terminal, a telephone number for identifying a caller at the time of call redirection, and a call redirection telephone number of a third party.

The call redirection command transmitted from the user terminal 11 is received via the website display processing unit 31 by the service command reception processing unit (switching command reception means) 32. Further, the call redirection command is transmitted via the command notification processing unit 33 to the command notification reception processing unit 21 of the connection control server 2.

The above operation describes an example in which the user A accesses the control screen in a state such that a session has been established between two telephone terminals. In another embodiment, a connection command between two telephone terminals may also be inputted via the control screen. Thus, the user A may access the control screen with the user terminal 11, specify a telephone number to be called, and input a call command. A call control and a connection control may be performed between the two telephone terminals by the connection control server 2 receiving the call command.

Operation in the above configuration will be described in detail with reference to FIGS. 4 to 7. In the following example, when the user A and the user B have a telephone conversation therebetween, the connection (destination) with the user B is forwarded to the user C so that the user B and the user C can have a telephone conversation therebetween. In the following example, a call connection between the users A and B is first performed on the control screen.

First, operation for a two-party call between the user A and the user B will be described with reference to FIG. 4 and the sequence diagram shown in FIG. 6. The user A operates the user terminal 11 so as to access the website of the web server 3 (Step S1; arrow Y1 in FIG. 4). At that time, a user ID and a password are required by the web server 3. In response thereto, the user A transmits his/her user ID and password from the user terminal 11. Then a user authentication is performed by the web server 3. If the user is successfully authenticated, control screen information is transmitted from the web server 3. Thus, a control screen indicated by the control screen information is displayed on a browser of the user terminal 11 (Step S2).

The user A selects a telephone number of the telephone terminal 13 of the user B, who is to be called, from an address book on the control screen. Alternatively, the user A directly inputs a telephone number of the telephone terminal 13 of the user B. Then the user A inputs a dial command. The user terminal 11 transmits a dial command to the web server 3 so as to connect between the telephone terminal 12 of the user A and the telephone terminal 13 of the user B (Step S3). The web server 3 receives the dial command and notifies the connection control server 2 of contents of the dial command (Step S4).

In response to the dial command of a two-party call, the connection control server 2 calls the telephone terminal 12 of the user A, who is a calling party, and the telephone terminal 13 of the user B, who is a called party, via the SIP server 4 (Steps S5 and S6; arrows Y2 and Y3 in FIG. 4). When the telephone terminals 12 and 13 respond to the calls, a session is established between the telephone terminals 12 and 13 (arrow S7 in FIG. 6; arrow Y4 in FIG. 4). Thus, the telephone terminals 12 and 13 of the two users A and B can have a telephone conversation therebetween.

Next, operation at the time of call redirection will be described with reference to FIG. 5 and the sequence diagram shown in FIG. 7. As described above, a control screen is displayed on the browser of the user terminal 11 of the user A (switching content display step: arrow Y5 in FIG. 5). The control screen is displayed as shown in FIG. 3. The user A may establish a two-party call with the telephone terminal 13 of the user B by using his/her own telephone terminal 12 and then access the web server 3 with the user terminal 11 so that the control screen shown in FIG. 3 is displayed on the user terminal 11.

In a case where a session has already been established between the telephone terminals 12 and 13 (arrow S7 in FIG. 7), the user A specifies a telephone number of the user C in order to enable a telephone conversation between the user B and the user C. At that time, if the user A pushes the “address book” button A12 on the control screen with the user terminal 11 (Step S8), then the web server 3 transmits address book data to the user terminal 11 and the address book data is displayed on the browser of the user terminal 11 (Step S9). The user A selects a telephone number of the telephone terminal 14 of the user C from among the address book data. The selected telephone number of the telephone terminal 14 is inputted into the “telephone number” input field (box) A22. When the user A then pushes the “call redirection” button A2, call redirection command information is transmitted to the web server 3 (Step S10) and received by the web server 3 (switching command reception step). The web server 3 notifies the connection control server 2 of contents of the call redirection command (switching request reception step: Step S11). The call redirection command includes information for identifying a session between the telephone terminal 12 of the user A, which is specified by an authentication of the user A, and the telephone terminal 13 of the user B, a call redirection telephone number of the telephone terminal 14 of the user C, and a telephone number of the telephone terminal 13 of the user B, who is to be a calling party.

Subsequently, the connection control server 2 which has received the notification of the call redirection contents calls the call redirection telephone terminal 14 of the user C (Step S12; arrow Y6 in FIG. 5). When the telephone terminal 14 of the user C responds to the call, the connection control server 2 transmits a switching command, which is for switching a connection of the session, to the telephone terminal 13 of the user B (Step S13; arrow Y7 in FIG. 5). Substantially at the same time, the connection control server 2 transmits a disconnection command to the telephone terminal 12 of the user A (Step S15; arrow Y9 in FIG. 5). Thus, a connection with the telephone terminal 13 of the user B is switched from the telephone terminal 12 of the user A to the telephone terminal 14 of the user C (connection switching step). As a result, a session is established between the telephone terminals 13 and 14 of the users B and C (arrows S14 and S16 in FIG. 7; arrow Y8 in FIG. 5).

As described above, the user A can access the web server 3 with the user terminal 11, select a telephone number on the control screen, and command telephone call redirection. Thus, telephone call redirection can be conducted accurately with easy operation. Further, since a telephone call redirection operation is performed by the connection control server 2, it is not necessary to provide a telephone call redirection function on each of the telephone terminals 12, 13, and 14. Accordingly, a telephone call redirection function can be provided at low cost.

Next, variations of the present embodiment will be described with reference to FIGS. 8 and 9. The above embodiment relates to an example in which telephone call redirection is conducted between the IP telephone terminals 12, 13, and 14. However, available telephone terminals are not limited to IP telephones.

FIG. 8 shows an example in which the user C has a telephone terminal 15 of a fixed subscriber line. The IP network N1 has a Public Switched Telephone Network (PSTN) gateway 41. The PSTN gateway 41 is connected to the telephone terminal 15 of the user C via Public Switched Telephone Networks (PSTN) N2. The user A who holds a telephone conversation with the telephone terminal 13 of the user B (arrow Y4) inputs a call redirection command to the web server 3 of the connection control system 1 with the user terminal 11 (arrow Y11). The connection control server 2 of the connection control system 1 calls the telephone terminal 15 of the user C via the SIP server 4, the Public Switched Telephone Network (PSTN) gateway 41, and the Public Switched Telephone Networks (PSTN) N2 (arrow Y12). The connection control server 2 transmits a session switching command to the telephone terminal 13 of the user B (arrow Y13). Subsequently, a session is established between the telephone terminals 13 and 15 of the users B and C (arrow Y14). Further, even if the telephone terminals 12 and 13 of the users A and B are on fixed subscriber lines, telephone call redirection can be provided in the same manner as described above. Furthermore, it is also possible to provide a three-party call as described in the following embodiments.

FIG. 9 shows an example in which the user A has a telephone terminal 16 of a cellular phone capable of simultaneous connection to another telephone terminal and a website. The connection control system 1 is connected to the telephone terminal 16 of the user A via a cellular phone network N3. In this case, the user A who holds a telephone conversation with the telephone terminal 13 of the user B (arrow Y4) simultaneously accesses the website of the web server 3 via the cellular phone network N3 with use of the cellular phone 16 which is used for the telephone conversation. Thus, the control screen is displayed on a display screen of the cellular phone 16. Then a call redirection command is inputted from the cellular phone 16. The call redirection command is transmitted to the web server 3 of the connection control system 1 (arrow Y21). The connection control server 2 of the connection control system 1 calls the telephone terminal 14 of the user C via the SIP server 4 (arrow Y22). The connection control server 2 transmits a session switching command to the telephone terminal 13 of the user B (arrow Y23). Thus, a session is established between the telephone terminals 13 and 14 of the users B and C (arrow Y24) so as to enable a telephone conversation between the telephone terminals 13 and 14. The cellular phone 16 of the user A may be other types of information processing terminals such as a personal computer having a telephone conversation function. Further, the configuration of this example is applicable to a three-party call as described in the following embodiments.

In the above embodiment, the user inputs a call redirection command or the like to the web server 3 via the browser operating on the user terminal 11 with a program provided by the web server 3. However, the present invention is not limited to the illustrated embodiment. That is, an application program for allowing a user to input the aforementioned call redirection command or other various commands to the web server 3 may be installed in the user terminal 11 as an independent program operating on the user terminal 11. Further, in the above embodiment, the user terminal 11 is a personal computer or a cellular phone. However, the user terminal 11 may be other types of information processing devices such as personal digital assistants (PDA) or a fixed subscriber telephone as long as the web server 3 is provided with a program for transmitting the call redirection command via the IP network N1.

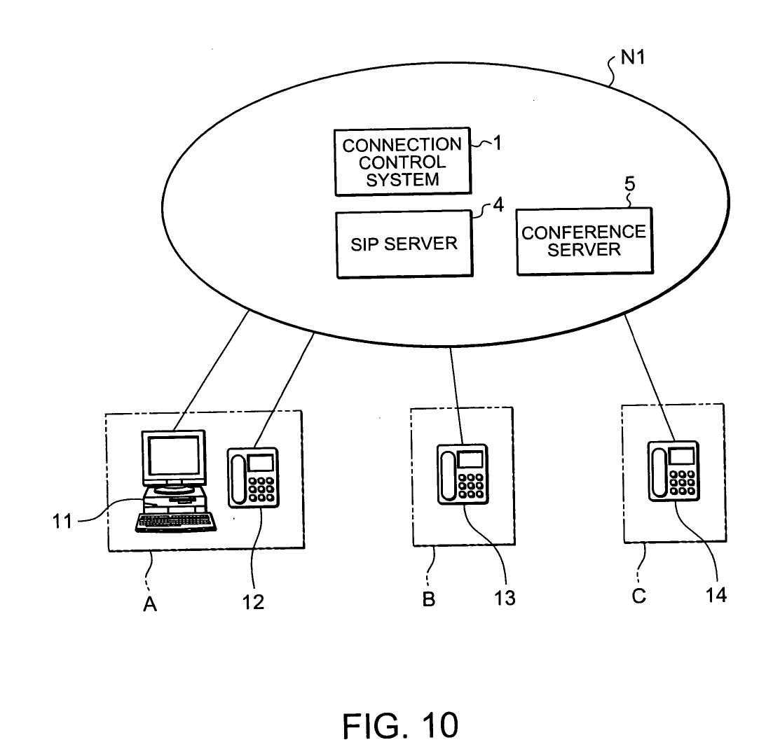

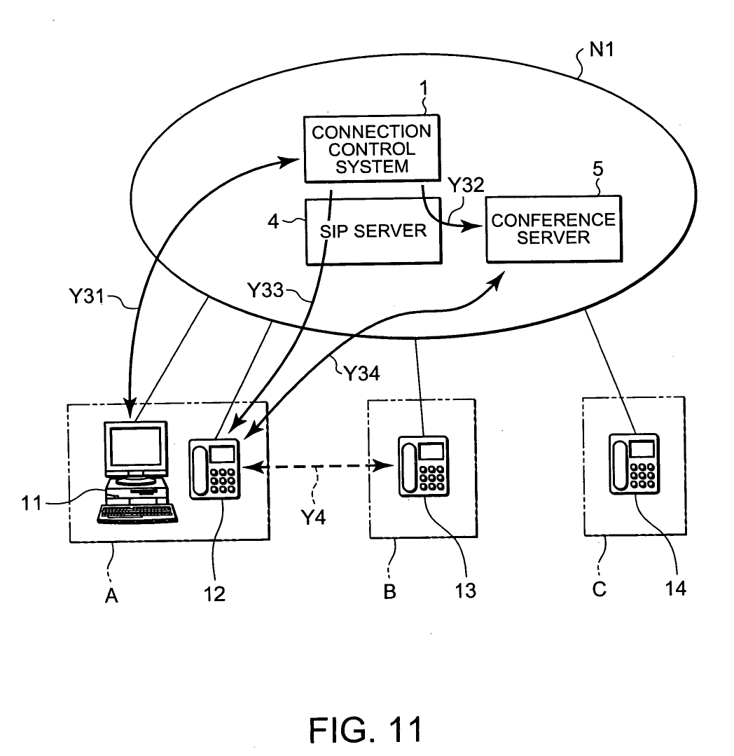

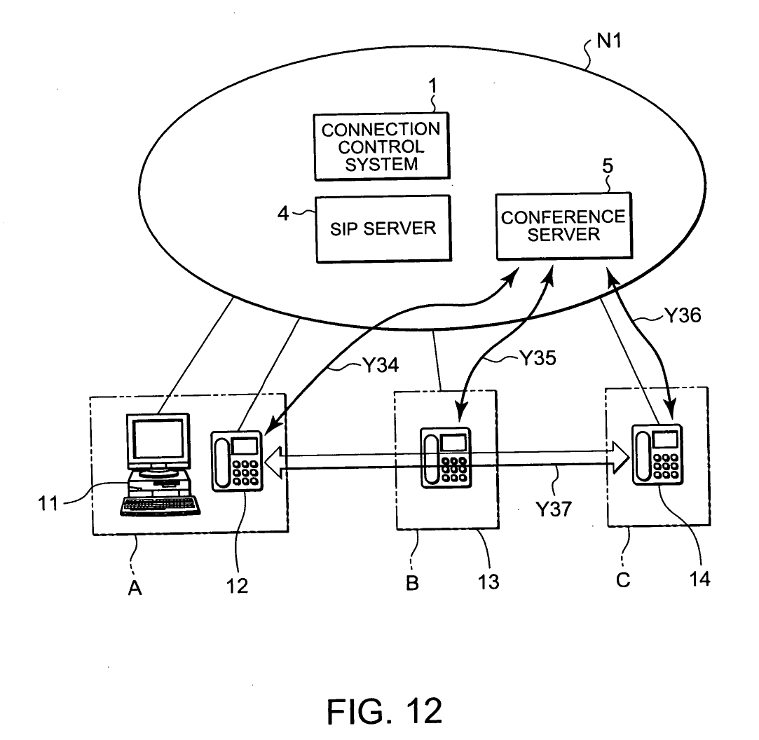

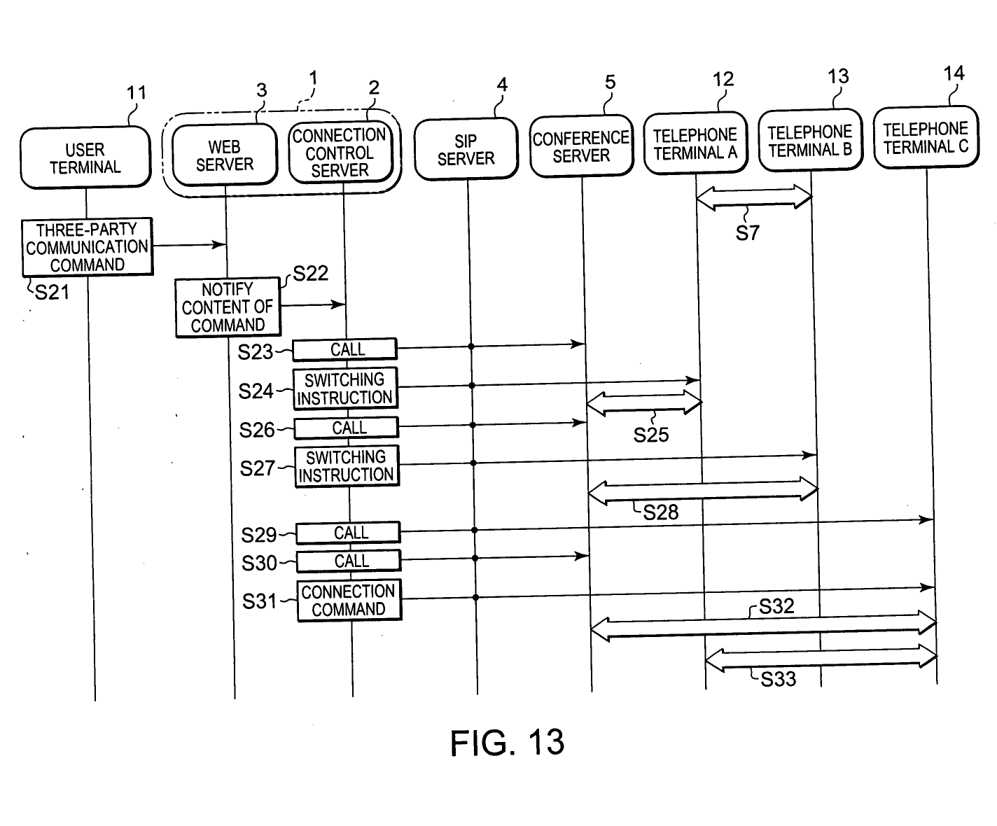

Next, a second embodiment of the present invention will be described below with reference to FIGS. 10 to 13. FIG. 10 is a block diagram showing a configuration of an entire network according to the second embodiment of the present invention. FIGS. 11 to 12 are explanation diagrams showing operation in the second embodiment. FIG. 13 is a sequence diagram showing operation in the second embodiment.

The network configuration is basically the same as that in the first embodiment. In the network configuration of the present embodiment, the IP network N1 further includes a conference server 5, which is a mixing server operable to mix sound information inputted from connected terminals and output the mixed sound information to the connected terminals. The conference server 5 has a function of connecting three or more user's telephone terminals to each other for providing a telephone conversation therebetween. With this arrangement, voices inputted from respective telephone terminals are synthesized or mixed in the conference server 5 and outputted directly to the telephone terminals. Thus, it is possible to provide a three-party call.

The session control processing unit 22, which is shown in FIG. 2, connects each of two connected telephone terminals to the conference server 5 in response to the fact that the command notification reception processing unit 21 receives a switching request of a session from the user terminal 11. Further, the session control processing unit 22 calls a telephone number of a third party to be newly added, which has been provided by the user terminal 11, and connects a telephone terminal of the third party to the conference server 5.

As shown in FIG. 3, the control screen indicated by control screen information transmitted from the web server 3 to the user terminal 11. Control screen information includes a “three-party call” button A1 for providing a three-party call function, a “telephone number” input field (box) A21 for inputting a telephone number of a third party to be newly added, and an “address book” button A11 for displaying previously registered telephone numbers. When the user A pushes the “address book” button A11, a list of telephone numbers registered for a three-party call is displayed on the control screen. When the user A selects one of the telephone numbers, the selected telephone number is automatically inputted into the “telephone number” Input field (box) A21. When the user A then pushes the “three-party call” button A1, a three-party call command is transmitted from a browser of the user terminal 11 to the web server 3. The three-party call command includes information for identifying a connected session of the telephone terminal of the user, a telephone number for identifying a telephone terminal of a caller, information for identifying a conference server, and a telephone number of a third party to be newly added.

Operation in the present embodiment will be described with reference to FIGS. 11 to 13 and the control screen shown in FIG. 3. In the following example, when the user A and the user B have a telephone conversation therebetween, the user C is newly added so as to enable a telephone conversation between the three users A, B, and C.

As shown in FIG. 13, a session of a two-party call has already been established between the telephone terminals 12 and 13 of the users A and B (arrow S7 in FIG. 13). The user A accesses the website of the web server 3 with the user terminal 11. Thus, a control screen is displayed on the browser of the user terminal 11 (switching content display step).

Subsequently, for a three-party call, the user A specifies a telephone number of the user C to be newly added on the control screen. At that time, if the user A pushes the “address book” button A11 on the control screen with the user terminal 11, then the web server 3 transmits address book data for a three-party call to the user terminal 11 and displays the address book data on the browser of the user terminal 11. The user A selects a telephone number of the telephone terminal 14 of the user C from among the address book data so as to input the selected telephone number into the “telephone number” input field (box) A21. When the user A then pushes the “three-party call” button A1, three-party call command information is transmitted to the web server 3 (Step 21) and received by the web server 3 (switching command reception step: arrow Y31 in FIG. 11). The web server 3 notifies the connection control server 2 of contents of the three-party call command (switching request reception step: Step S22).

Subsequently, the connection control server 2 which has received the notification of the three-party call contents calls the conference server 5 (Step S23; arrow Y32 in FIG. 11) and simultaneously transmits a session switching command to the telephone terminal 12 of the user A (Step S24; arrow Y33 in FIG. 11). Thus, a connection ends (nodes) of the telephone terminal 12 of the user A is switched to the conference server 5 (connection switching step). As a result, a session is established between the telephone terminal 12 of the user A and the conference server 5 (arrow S25 in FIG. 13; arrow Y34 in FIG. 11). Similarly, the connection control server 2 calls the conference server 5 (Step S26) and simultaneously transmits a session switching command to the telephone terminal 13 of the user B (Step S27). Thus, a connection ends (nodes) of the telephone terminal 13 of the user B is switched to the conference server 5 (connection switching step). As a result, a session is established between the telephone terminal 13 of the user B and the conference server 5 (arrow S28 in FIG. 13; arrow Y35 in FIG. 12).

Further, the connection control server 2 calls the telephone terminal 14 of the user C as a third party to be newly added (Step S29). Simultaneously, the connection control server 2 calls the conference server 5 (Step S30). When the telephone terminal 14 of the user C responds to the call, the connection control server 2 transmits a connection request to the telephone terminal 14 (Step S31). Subsequently, a session is established between the telephone terminal 14 of the user C and the conference server 5 (arrow S32 in FIG. 13; arrow Y36 in FIG. 12).

Thus, the three telephone terminals 12, 13, and 14 of the users A, B, and C are connected to each other via the conference server 5 so as to enable a three-party call (arrow S33 in FIG. 13; arrow Y37 in FIG. 12). In this case, the user A can access the web server 3 with the user terminal 11 and command a three-party call on the control screen. Thus, a connection operation can readily be performed with high accuracy. Further, the three-party call operation is performed by the connection control server 2 and the conference server 5. Accordingly, it is not necessary to provide a three-party call function on each of the telephone terminals 12, 13, and 14. Furthermore, a three-party call function can be provided at low cost.

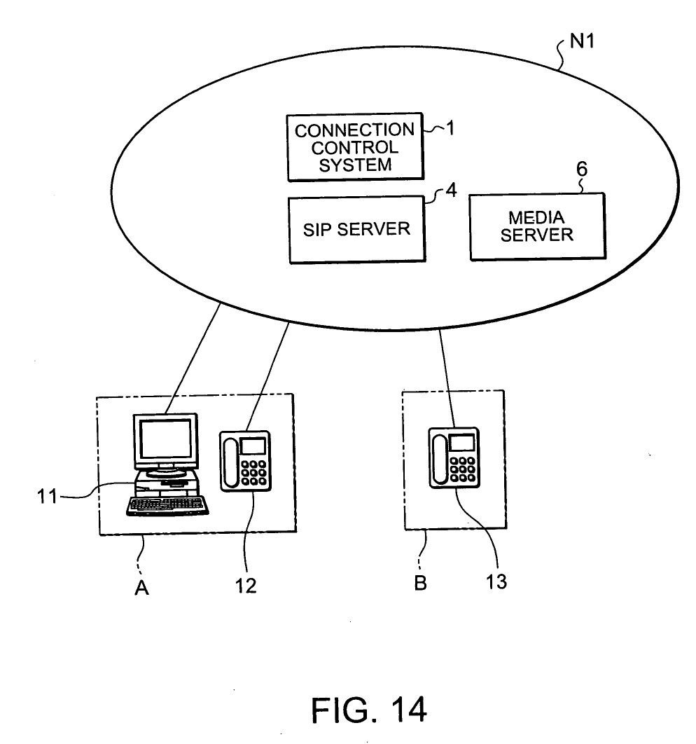

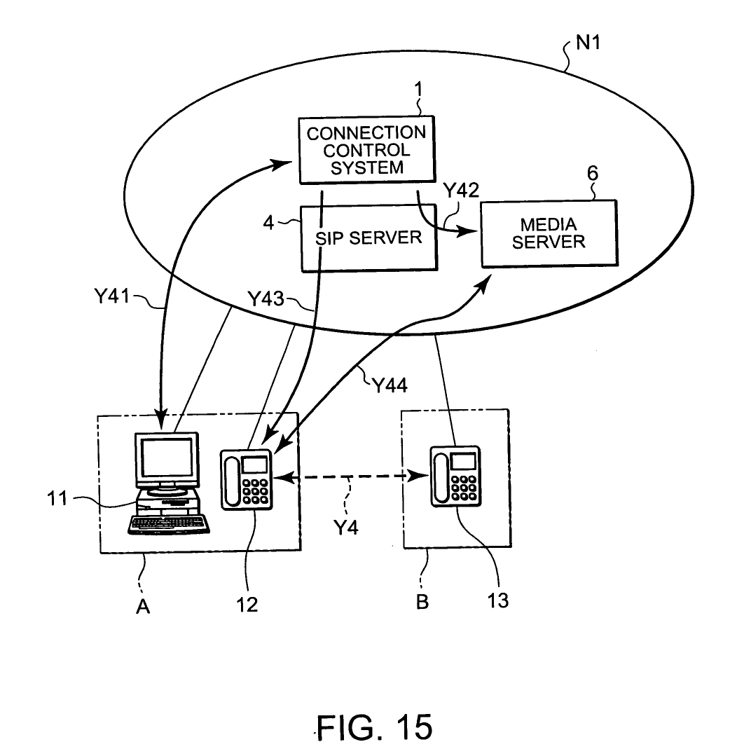

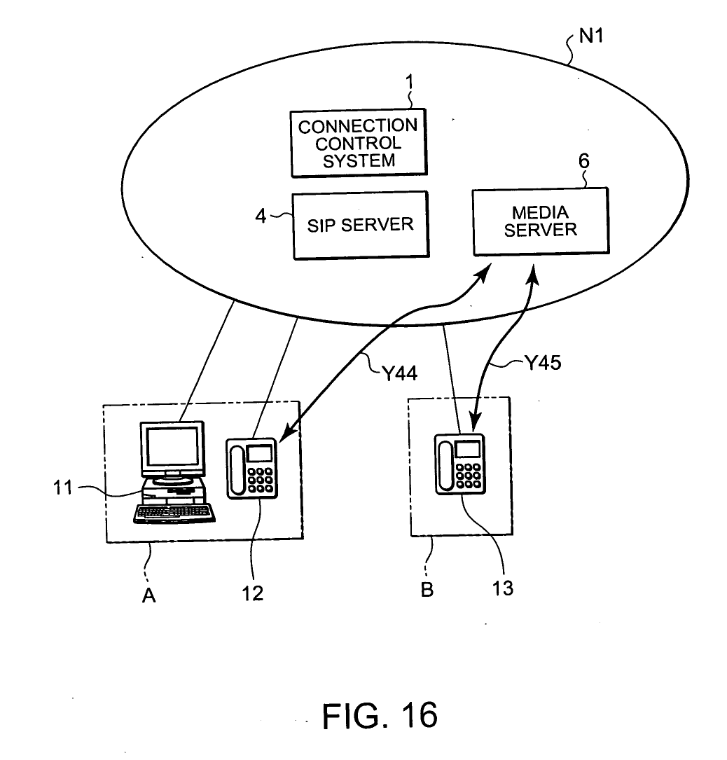

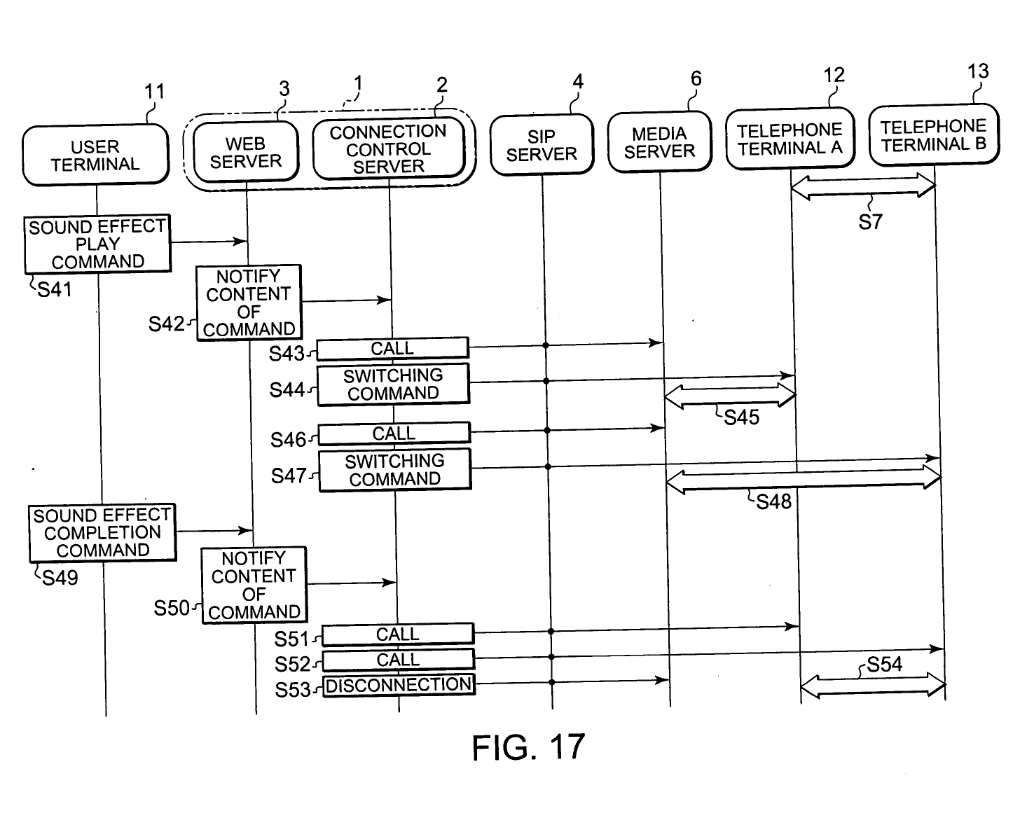

Next, a third embodiment of the present invention will be described below with reference to FIGS. 14 to 17. FIG. 14 is a block diagram showing a configuration of an entire network according to the third embodiment of the present invention. FIGS. 15 and 16 are explanation diagrams showing operation in the third embodiment. FIG. 17 is a sequence diagram showing operation in the third embodiment.

The network configuration is basically the same as that in the first embodiment. In the network configuration of the present embodiment, the IP network N1 further includes a media server 6 provide content information such as sound information or image information to connected telephone terminals. For example, the media server 6 is managed by an Internet service provider or a telephone service provider. The media server 6 stores therein sound information, which includes sound effects (e.g., hand clapping sounds) or music (music-on-hold or BGM) prepared by the manager. Further, the media server 6 also stores sound information produced by users. Sound information selected by a user is outputted to a connected telephone terminal of the user. The media server 6 also has a function of a mixing server as with the aforementioned conference server 5. For example, when a user selects playing BGM, sound information to be played (BGM) and sound information inputted from a connected telephone terminal of the user are mixed with each other and outputted to the telephone terminals.

In order to provide sound information, in the present embodiment, the session control processing unit 22, which is shown in FIG. 2, connects each of two connected telephone terminals to the media server 6 in response to the fact that the command notification reception processing unit 21 receives a switching request of a session from the user terminal 11. Further, the session control processing unit 22 restores a connection between telephone terminals after sound information has been provided.

A control screen defined by control screen information transmitted from the web server 3 to the user terminal 11 is the same as shown in FIG. 3. Particularly, in order to provide a sound effect play function, the control screen includes a “sound effect” button A3, a “sound select” Input field (box) A23 for selecting a sound effect to be provided, and a “music box” button A13 for displaying previously registered sound effect files. Further, in order to provide a music-on-hold play function, the control screen includes a “hold” button A4, a “melody select” input box A24 for selecting music-on-hold to be provided, and a “music box” button A14 for displaying previously registered music-on-hold files. Furthermore, in order to provide a BGM function, the control screen includes a “BGM” button A5, a “BGM select” input field (box) A25 for selecting BGM to be provided, and a “music box” button A15 for displaying previously registered BGM files. Additionally, the control screen includes a “record” button A31 for inputting a command to record a telephone conversation and a “disconnect” button A32 for inputting a disconnection command of a call.

When the user pushes the “music box” button A13, a list of registered sound effect files is displayed on the control screen. When the user selects one of the sound effect files, the selected music file is automatically inputted into the “sound” input field (box) A23. At that time, the user may select and purchase a pay sound effect file. Sound effect files produced and registered by the user are displayed in a selectable manner within a pull-down menu of the “sound” input field (box) A23. When the user then pushes the “sound effect” button A3, a sound play command is transmitted from a browser of the user terminal to the web server 3. The sound play command includes information for identifying a connected session of the telephone terminal of the user, a telephone number for identifying the telephone terminal of the user, information for identifying a media server, and information for identifying the selected sound information file.

When the user is to input a command to play music-on-hold or BGM, the user inputs and operates in the same manner as described above on the control screen.

Operation in the above configuration will be described with reference to FIGS. 15 to 17 and the control screen shown in FIG. 3. In the following example, when the user A and the user B have a telephone conversation therebetween, the user A provides a sound effect to the user B.

As shown in FIG. 17, a session has already been established between the telephone terminals 12 and 13 of the users A and B. It is assumed that a two-party call is provided between the users A and B (arrow S7 in FIG. 17; arrow Y4 in FIG. 15; see FIG. 6). At that time, a control screen defined by control screen information transmitted from the web server 3 is displayed on the browser of the user terminal 11 (switching content display step).

Next, the user A selects a sound effect on the control screen in order to provide the sound effect. At that time, the user A pushes the “music box” button A13 or a pull-down button in the “sound” Input field (box) A23 on the control screen with the user terminal 11. Then a list of selectable sound effect files is transmitted from the web server 3 to the user terminal 11 and displayed on the browser. The user A selects a sound effect file that is wanted to be heard by the user B from among the displayed list, inputs the selected sound effect file into the “sound” input field (box) A23, and pushes the “sound effect” button A3. Thereafter, sound effect play command information is transmitted to the web server 3 (Step S41) and received by the web server 3 (switching command reception step: arrow Y41 in FIG. 15). Subsequently, the web server 3 notifies the connection control server 2 of contents of the sound effect play command (switching request reception step: Step S42).

The connection control server 2 receives the notification of the sound effect play command and calls the media server 6 (Step S43; arrow Y42 in FIG. 15). Simultaneously, the connection control server 2 transmits a session switching command to the telephone terminal 12 of the user A (Step S44; arrow Y43 in FIG. 15). Thus, a connection ends (nodes) of the telephone terminal 12 of the user A is switched to the media server 6 (connection switching step). As a result, a session is established between the telephone terminal 12 of the user A and the media server 6 (arrow S45 in FIG. 17; arrow Y44 in FIG. 15). Similarly, the connection control server 2 receives a notification of the sound effect play command, calls the media server 6 (Step S46), and transmits a session switching command to the telephone terminal 13 of the user B (Step S47). Thus, a connection ends (nodes) of the telephone terminal 13 of the user B is switched to the media server 6 (connection switching step). As a result, a session is established between the telephone terminal 13 of the user B and the media server 6 (arrow S48 in FIG. 17; arrow Y45 in FIG. 16).

The sound effect played by the media server 6 is outputted to the telephone terminal 12 of the user A and the telephone terminal 13 of the user B. For example, a sound effect of hand clapping sounds is outputted on a joyful occasion.

When a playback of the sound effect is completed, the user A inputs a sound effect completion command from the user terminal 11. The connection control server 2 is notified of contents of the command via the web server 3 (Steps 849 and S50). Then the connection control server 2 calls the +telephone terminal 12 of the user A and the telephone terminal 13 of the user B connected to the media server 6 (Steps S51 and S52) and simultaneously disconnects the connection of the media server 6 (Step S53). Thereafter, a session is established between the telephone terminal 12 of the user A and the telephone terminal 13 of the user B. Thus, the users A and B can have a telephone conversation therebetween (arrow S54 in FIG. 17).

If the user A selects playing music-on-hold in Step S41, then the connection control apparatus operates in the same manner as described above. Further, if the user A selects playing BGM, then BGM is outputted to the telephone terminals 12 and 13 connected to the media server 6. The BGM is mixed with voices inputted from the connected telephone terminals 12 and 13 and then outputted to the telephone terminals 12 and 13. Thus, the users A and B can output the selected BGM while having a telephone conversation with each other.

When the user A pushes the “record” button A31 while BGM or a sound effect is being outputted, the media server 6 records a telephone conversation including the BGM or the sound effect. The media server 6 and the web server 3 can store the recorded telephone conversation. The media server 6 can record only a telephone conversation. The stored record sound information is utilized as a telephone record and can be used as sound contents, which will be described later.

When the user A accesses the web server 3 with the user terminal 11 and operates on the control screen, the user A can provide sound information such as music or a sound effect so that a person having a telephone conversation with the user A or both of the user A and a person having a telephone conversation with the user A can hear the music or the sound effect. This operation is so easy that convenience of users can be improved. Further, since the aforementioned sound information providing service is achieved via the connection control server 2 and the media server 6, it is possible to offer a sound information providing service without a sound information playing function provided on each of the telephone terminals 12, 13, and 14.

The media server 6 can distribute not only sound information but also image information. Specifically, the media server 6 stores image information provided by various service providers or various image information produced by users. In a case where the telephone terminals 12, 13, and 14 are visual telephones capable of displaying images, images can be distributed to the telephone terminals and displayed on the telephone terminals during a telephone conversation. With this function, a person having a telephone conversation can view the images. Thus, users can have a telephone conversation with each other while viewing the same images. In a case where image information is distributed, when the user A pushes the “record” button A31 on the control screen shown in FIG. 3, the distributed images are mixed with a telephone conversation. The mixed information is stored as multimedia information in the media server 6.

Further, switching of a session is repeated when the “record” button is operated to use a function of storing multimedia information as described above. It is possible to store telephone conversations with various persons, and sound information and image information outputted from the media server 6. Original sound sources and program contents are produced based on the aforementioned various sound information and image information. These contents such as sound sources are used for music-on-hold, sound effects, and BGM. Further, these contents such as sound sources can be broadcast as programs on the Internet.

According to the present invention, telephone call redirection and a three-party call can be provided with an easy operation without various functions mounted on telephone terminals or introduction of new telephone terminals. Further, new telephone services can be provided. Accordingly, it is possible to improve convenience and satisfaction of users in telephone use.

The above embodiments have been described as examples to which the present invention is preferably applied. However, it should be understood that various changes and modifications may be made therein without departing from the spirit of the present invention.

The present invention has an industrial applicability in that Internet service providers or communication common carriers can provide services such as telephone call redirection or a three-party call to users having a telephone conversation without any special functions mounted on their telephone terminals.

What is claimed is:

1. A connection control apparatus, disposed on a network, for controlling a connection state of telephone terminals connected to each other via the network, said connection control apparatus comprising:
switching request reception means for receiving a switching request of a session established between said telephone terminals from an information processing terminal connected to the network; and
connection switching means for switching connection ends of the session between the telephone terminals in response to the switching request.

2. The connection control apparatus according to claim 1, wherein:
said connection switching means is operable to switch at least one of the connection ends in the session between the telephone terminals into another device.

3. The connection control apparatus according to claim 2, wherein:
said connection switching means is operable to call the other device and connect the other device to at least one of telephone terminals serving as the connection ends in the session.

4. The connection control apparatus according to claim 2, wherein:
said connection switching means is operable to call the other device and connect the other device to both telephone terminals serving as the connection ends in the session.

5. The connection control apparatus according to claim 3, wherein:
said connection switching means is operable to call another telephone terminal as the other device and connect the other telephone terminal to the at least one of telephone terminals serving as the connection ends in the session.

6. The connection control apparatus according to claim 2, wherein:
said connection switching means is operable to call, as the other device, a media server for providing content information including a sound and an image to the telephone terminals and connect the media server to at least one of telephone terminals serving as the connection ends in the session.

7. The connection control apparatus according to claim 2, wherein:
said connection switching means is operable to call, as the other device, a mixing server for mixing information supplied from predetermined devices connected thereto to produce the mixed input information to the connected predetermined devices and connect the media server to at least one of telephone terminals serving as the connection ends in the session.

8. The connection control apparatus according to claim 7, wherein:
said connection switching means is operable to call a third party's telephone terminal and connect the third party's telephone terminal to the mixing server.

9. The connection control apparatus according to claim 1, wherein:
said connection switching means is operable to switch the connection ends of the session via a call control server, disposed on the network, for performing a call control and a connection control for telephone terminals.

10. A web server, connected to a connection control apparatus disposed on a network, for opening a website which receives access from an information processing terminal connected to the network, said web server comprising:
switching command reception means for receiving a switching request of a session established between telephone terminals connected to each other via the network from the information processing terminal and for notifying the connection control apparatus of the switching request.

11. The web server according to claim 10, further comprising:
switching content information storage means for preliminarily storing switching content of the session; and
switching content display means for displaying the switching content on the information processing terminal in a selectable manner; and
wherein said switching command reception means is operable to receive, as a switching command, switching content selected from the information processing terminal on an indication by said switching content display means.

12. The web server according to claim 11, wherein:
said switching content display means is operable to display, as the switching content, an indication of call redirection and telephone numbers of destination of the call redirection on the information processing terminal.

13. The web server according to claim 11, wherein:
said switching content display means is operable to display, as the switching content, an indication of a three-party call and telephone numbers of a possible third party to be added on the information processing terminal.

14. The web server according to claim 11, wherein:
said switching content display means is operable to display, as the switching content, an indication of transmission of predetermined content information to a telephone terminal and a list of content information to be selected on the information processing terminal.

15. A connection control system comprising a connection control apparatus disposed on a network and a web server connected to said connection control apparatus, said connection control apparatus controlling a connection state of telephone terminals connected to each other via the network, said web server opening a website which receives access from an information processing terminal connected to the network, wherein:
said web server comprises switching command reception means for receiving a switching request of a session established between the telephone terminals from the information processing terminal and for notifying said connection control apparatus of the switching request; and
said connection control apparatus comprises:
switching request reception means for receiving the switching request; and
connection switching means for switching connection ends of the session between the telephone terminals in response to the switching request.

16. The connection control system according to claim 15, wherein:
said connection switching means is operable to switch at least one of the connection ends in the session between the telephone terminals into another device.

17. The connection control system according to claim 16, wherein:
said connection switching means is operable to call the other device and connect the other device to at least one of telephone terminals serving as the connection ends in the session.

18. The connection control system according to claim 16, wherein:
said connection switching means is operable to call the other device and connect the other device to both of the telephone terminals serving as the connection ends in the session.

19. The connection control system according to claim 17, wherein:
said connection switching means is operable to call another telephone terminal as the other device and connect the other telephone terminal to the at least one of the telephone terminals serving as the connection ends in the session.

20. The connection control system according to claim 16, wherein:
said connection switching means is operable to call, as the other device, a media server for providing content information including a sound and an image to the telephone terminals and connect the media server to at least one of telephone terminals serving as the connection ends in the session.

21. The connection control system according to claim 16, wherein:
said connection switching means is operable to call, as the other device, a mixing server for mixing information supplied from predetermined devices thereto to produce the mixed input information to the connected predetermined devices and connect the mixing server to at least one of telephone terminals serving as the connection ends in the session.

22. The connection control system according to claim 21, wherein:
said connection switching means is operable to call a third party's telephone terminal and connect the third party's telephone terminal to the mixing server.

23. The connection control system according to claim 15, wherein:
said connection switching means is operable to switch the connection ends of the session via a call control server, disposed on the network, for performing a call control and a connection control for telephone terminals.

24. The connection control system according to claim 15, wherein said web server further comprises:
switching content information storage means for preliminarily storing switching content of the session; and
switching content display means for displaying the switching content on the information processing terminal in a selectable manner, and
wherein said switching command reception means is operable to receive, as a switching command, the switching content selected from the information processing terminal on an indication by said switching content display means.

25. The connection control system according to claim 24, wherein:
said switching content display means is operable to display, as the switching content, an indication of call redirection and telephone numbers of destination of the call redirection on the information processing terminal.

26. The connection control system according to claim 24, wherein:
said switching content display means is operable to display, as the switching content, an indication of a three-party call and telephone numbers of a possible third party to be added on the information processing terminal.

27. The connection control system according to claim 24, wherein:
said switching content display means is operable to display, as the switching content, an indication of transmission of content information to a telephone terminal and a list of content information to be selected on the information processing terminal.

28. A program for controlling, by a connection control computer disposed on a network, a connection state of telephone terminals connected to each other via the network, the program making the connection control computer execute the steps of:
receiving a switching request of a session established between the telephone terminals from an information processing terminal connected to the network; and
switching connection ends of the session between the telephone terminals in response to the switching request.

29. The program according to claim 28, wherein:
said switching step switches at least one of the connection ends in the session between the telephone terminals into another device.

30. The program according to claim 29, wherein:
said switching step calls the other device and connects the other device to at least one of telephone terminals serving as the connection ends in the session.

31. The program according to claim 29, wherein:
said switching step calls the other device and connects the other device to both of the telephone terminals serving as the connection ends in the session.

32. The program according to claim 30, wherein:
said switching step calls another telephone terminal as the other device and connects the other telephone terminal to the at least one of the telephone terminals serving as the connection ends in the session.

33. The program according to claim 29, wherein:
said switching step calls, as the other device, a media server for providing content information including a sound and an image to the telephone terminals and connects the media server to at least one of telephone terminals serving as the connection ends in the session.

34. The program according to claim 29, wherein:
said switching step calls, as the other device, a mixing server for mixing information supplied from predetermined device connected thereto to produce the mixed input information to the connected predetermined devices and
connects the media server to at least one of telephone terminals serving as the connection ends in the session.

35. A program for making the web server execute a process, the web server being connected to a connection control apparatus disposed on a network, the connection control apparatus controlling a connection state of telephone terminals connected to each other via the network, the web server opening a website which receives access from an information processing terminal connected to the network, the process comprising the step of:
receiving a switching request of a session established between the telephone terminals from the information processing terminal to notify the connection control apparatus of the switching request.

36. The program according to claim 35, wherein said process further comprises a step of displaying switching content of the session which is preliminarily stored in switching content information storage means on the information processing terminal in a selectable manner,
wherein said receiving step receives, as a switching command, the switching content selected on an indication by said displaying step.

37. The program according to claim 36, wherein said displaying step displays, as the switching content, an indication of call redirection and telephone numbers of destination of the call redirection on the information processing terminal.

38. The program according to claim 36, wherein said displaying step displays, as the switching content, an indication of a three-party call and telephone numbers of a possible third party to be added on the information processing terminal.

39. The program according to claim 36, wherein said displaying step displays, as the switching content, an indication of transmission of content information to a telephone terminal and a list of content information to be selected on the information processing terminal.

40. A connection control method of controlling, in a connection control apparatus disposed on a network, a connection state of telephone terminals connected to each other via the network, said method comprising:
a switching request receiving step of receiving a switching request of a session established between the telephone terminals from an information processing terminal connected to the network; and
a connection switching step of switching connection ends of the session between the telephone terminals in response to the switching request.

41. The connection control method according to claim 40, wherein:
said connection switching step comprises a step of switching at least one of telephone terminals serving as the connection ends in the session between the telephone terminals into another device.

42. The connection control method according to claim 41, wherein:
said connection switching step comprises a step of calling the other device to connect the other device to at least one of telephone terminals serving as the connection ends in the session.

43. The connection control method according to claim 41, wherein:
said connection switching step comprises a step of calling the other device to connect the other device to both of the telephone terminals serving as the connection ends in the session.

44. The connection control method according to claim 42, wherein:
said connection switching step comprises a step of calling another telephone terminal as the other device to connect the other telephone terminal to the at least one of the connected telephone terminals serving as the connection ends in the session.

45. The connection control method according to claim 41, wherein said connection switching step comprises the steps of:
calling, as the other device, a media server for providing content information including a sound and an image to the telephone terminals as the other device; and
connecting the media server to at least one of telephone terminals serving as the connection ends in the session.

46. The connection control method according to claim 41, wherein:
said connection switching step comprises the steps of:
calling, as the other device, a mixing server for mixing information supplied from predetermined devices connected thereof to produce the mixed input information to the connected predetermined devices; and
connecting the media server to at least one of telephone terminals serving as the connection ends in the session.

47. The connection control method according to claim 46, wherein:
said connection switching step further comprises the steps of:
calling a third party's telephone terminal; and
connecting the media server to the third party's telephone terminal.

48. The connection control method according to claim 40, further comprising:
a switching command reception step before said switching request reception step in which a web server, connected to the connection control apparatus, for opening a website which receives access from the information processing terminal receives a switching request of a session established between the telephone terminals on the website to notify the connection control computer of the switching request.

49. The connection control method according to claim 48, further comprising:
a switching content display step before said switching command reception step in which the web server displays switching content of the session which is preliminarily stored in switching content information storage means on the information processing terminal in a selectable manner, and wherein;
said switching command reception step comprises a step of receiving, as a switching command, the switching content selected on an indication by said switching content display step.

50. The connection control method according to claim 49, wherein:
said switching content display step comprises a step of displaying, as the switching content, an indication of call redirection and telephone numbers of destination of the call redirection on the information processing terminal.

51. The connection control method according to claim 49, wherein: said switching content display step comprises a step of displaying, as the switching content, an indication of a three-party call and telephone numbers of a possible third party to be added on the information processing terminal.

52. The connection control method according to claim 49, wherein:
said switching content display step comprises a step of displaying, as the switching content, as an indication of transmission of content information to a telephone terminal and a list of content information to be selected on the information processing terminal.
